(19) United States
(12) Patent Application Publication
(10) Pub. No.: US 2012/0153660 A1
(43) Pub. Date: Jun. 21, 2012

(54) DEVICE AND METHOD FOR PLACING INDICIA ON VEHICLE FUEL DOORS

(76) Inventor: Jeffrey C. Golden, Escondido, CA (US)

(21) Appl. No.: 13/314,381

(22) Filed: Dec. 8, 2011

Related U.S. Application Data
(60) Provisional application No. 61/423,518, filed on Dec. 15, 2010.

(51) Int. Cl. B62D 25/24; B23P 17/00

(52) U.S. Cl. 296/97.22; 29/527.2

(57) ABSTRACT

The present invention is directed to a fuel door cover adapted for a shrink fit engagement upon a fuel door of a vehicle, typically displaying indicia chosen by the driver of the vehicle.

### CROSS-REFERENCES

This application claims priority from U.S. Provisional Patent Application Ser. No. 61/423,518 by Jeffrey C. Golden, filed Dec. 15, 2010 and entitled “Device and Method for Placing Indicia on Vehicle Doors,” the contents of which are incorporated herein in their entirety by this reference.

### FIELD OF THE INVENTION

This disclosed device and method relate to the placement of indicia upon vehicles. More specifically, it relates to a means and method to semi-permanently engage indicia such as sports team logos, ads, or other decorative or functional indicia, to a vehicle fuel door, in a manner which will not cause damage to the finish of the vehicle, and which may be changed, replaced, or removed at a later date with no damage to the vehicle exterior surface.

### BACKGROUND OF THE INVENTION

Advancement in automotive technologies and aerodynamics have driven increasing change since the first automobile. For reasons of safety and streamline capabilities it is generally seen that fuel tanks are hidden from view by the vehicle body while the fill tube and gas cap are recessed and covered by a fuel door on the exterior surface of the vehicle. The fuel door is usually hinged to swing out of the closed position. Conventionally, the fuel door has the same finish as the surrounding body of the vehicle to render it substantially indiscernible therefrom when viewed from a distance.

Such vehicle finished surfaces modernly are of a polymer type of paint and generally include a shiny top coat to give the vehicle a shiny or waxed appearance. As a consequence, vehicle owners are generally recalcitrant to attach anything to the body exterior surface area which might damage or otherwise impair the finish over time. Two reasons generally drive this behavior, one being the owner's desire to have a clean and shiny vehicle. The second reason has to do with resale value since a vehicle with an impaired or scratched finish will have value deducted from it. Owners of leased vehicles suffer the same consequence when turning in the vehicle at the end of the lease should they have attached something to the vehicle which scratches or impairs the finish, or which cannot be removed easily.

However, a great many drivers desire to display symbols, logos, and other forms of communication of their hobbies or sports teams and the like on their vehicles. Stickers are a common means to communicate one's message on a vehicle, but many problems arise with stickers. Stickers can have a very permanent means of attachment to the vehicle surface. When removal is desired it can require harsh chemicals which can injure painted surfaces. Further, even when peeled and not cleaned, stickers can leave a sticky residue behind which is unsightly and can cause damage. The same problems occur with decals. Therefore, those who wish to change vehicle graphics, or remove them when selling their vehicle, will spend countless hours doing so.

Similarly full vehicle wraps or “skins” encompass a larger scale version of the sticker where graphics can be displaced on the entire body of a vehicle as seen for advertisement. This of course is more costly and not attractive to the everyday enthusiast who wishes to support a local sports team for a seasonal period. Another system of customizing vehicles has been proposed by the automobile manufacturer Toyota in its concept vehicle designated Fun-VII with an electronically customizable exterior; however, such a system is only in the conceptual stages and poses problems of cost, vehicle structural integrity, and vehicle safety. Other modes of indicia engagement to vehicles are available, however the problems encountered in the various available modes of prior art do not allow for easy and secure engagement, as well as replacement of indicia securely to a small surface area such as a vehicle fuel door as set forth by the current invention.

The present invention solves the aforementioned shortcomings of the prior art of attachment of sports related and other indicia to vehicles. The various modes of the device and method herein allow for an easy yet secure engagement of decorative indicia to a fuel door of a vehicle. While yielding such a secure mount, the present invention is removable without harming the paint or other surface of the vehicle on which it is engaged.

### SUMMARY OF THE INVENTION

With respect to the above, before explaining at least one preferred embodiment of the fuel door indicia engagement system and method herein in detail or in general, it is to be understood that the invention is not limited in its application to the details of construction and to the arrangement of the components or the steps set forth in the following description or illustrated in the drawings, The various apparatus and methods of the disclosed for placement of indicia on vehicle fuel doors, are capable of other embodiments, and of being practiced and carried out in various ways, all of which will be obvious to those skilled in the art, once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing other modes of engaging indicia upon vehicle fuel doors, and, for carrying out the several purposes of the present disclosed device and method. It is important, therefore, that the embodiments, objects and claims herein, be regarded as including such equivalent construction and methodology insofar as they do not depart from the spirit and scope of the present. invention.

The device herein described and disclosed introduces a means and method to engage indicia to a vehicle fuel door in a fashion which is easy, convenient, and non-damaging. The present invention allows for graphics, logos, symbols, and the like to be seen from an easily viewed location on a vehicle. Similarly the fuel door cover of the present invention can be applied by the user in a manner that does not damage the integrity of the vehicle fuel door operation of opening and closing nor will it cause any damage to the paint when removed.

In one preferred mode the device, the body of the device providing the surface for the indicia, is made of a UV resistant, shrink wrap film, on which indicia is pre-printed, or which in one mode may be printed by the user. In this mode, the body of the device providing the canvas for the indicia is adapted in size and shape to be fitted to lay flat across the exterior surface of the fuel door without interfering with the hinges. In this mode, the body of the device is configured with a lip portion to overlap the circumferential edges of the fuel door. A curved stiffener may be included in or attached to the lip portion to maintain its shape and dimensional characteristics as the plastic body is heated to shrink.

Engagement to a taut and smooth surface is provided by the employment of heat which is applied to the film forming the body. The heat causes the film to shrink whereby the overlapped edges of the device will grip from the interior surface and the circumferential edge of the fuel door thereby engaging the film to the exterior surface.

Another mode of the invention provides a means for the user to make his or her own gas door engageable device by printing their indicia upon a preformed door cover which is positioned on a sheet of printing material adapted to hold the flat surface of the shrink wrap plastic in place in a manner adapted to receive the printed indicia thereon. This mode would work well where users wish to use their own indicia or photos, or to buy licensed logos and such from sports teams which are digitized and applicable using a computer program and printer adapted to the task.

### BRIEF DESCRIPTION OF THE DRAWINGS

These and other features, aspects, and advantages of the present invention will become better understood with reference to the following description, appended claims, and accompanying drawings where:

FIG. 1 is a view of the disclosed device in an as-used position mounted to the fuel door of a vehicle.

FIG. 2 is a view of the device engaged to a fuel door showing the rear engaging lip portion in dotted line.

FIG. 3a depicts the device in a close-up engaged in the as-used portion on the fuel door.

FIG. 3b shows a rear view of the fuel door and the overlapping portion of the device folded around the circumferential edge of the door.

FIG. 4 shows another mode of the device herein.

FIG. 5a shows another view of the device as shown in FIG. 4.

FIG. 5b shows yet another view of the device as shown in FIG. 4 showing cut-outs for engagement with the hinge of the fuel door.

FIG. 6 shows a mode of the device engaged to a scrim adapted to register the planar portion of the plastic body in an inkjet printer so as to allow a user to print their own indicia thereon.

### DETAILED DESCRIPTION OF THE INVENTION

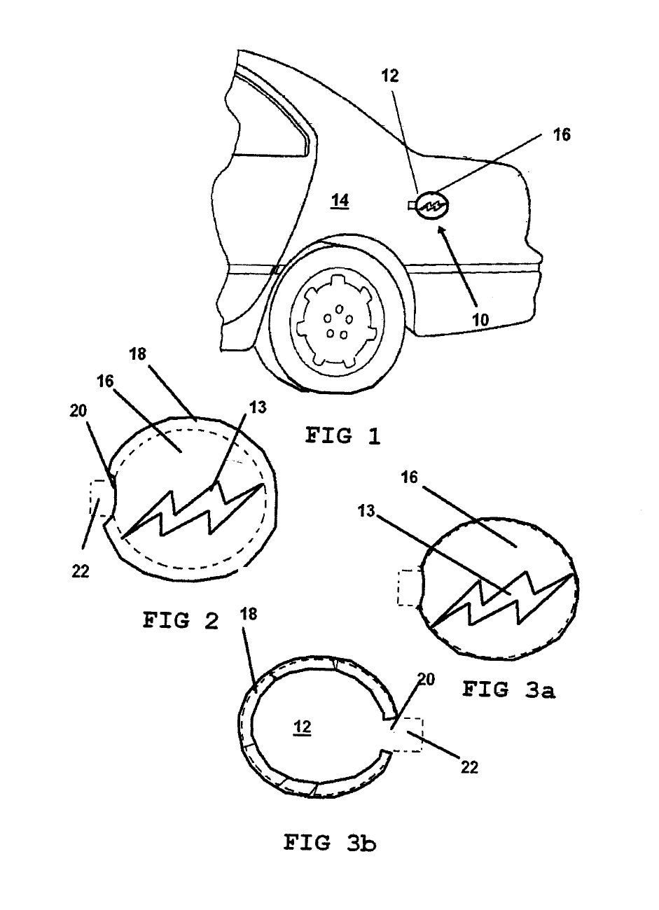

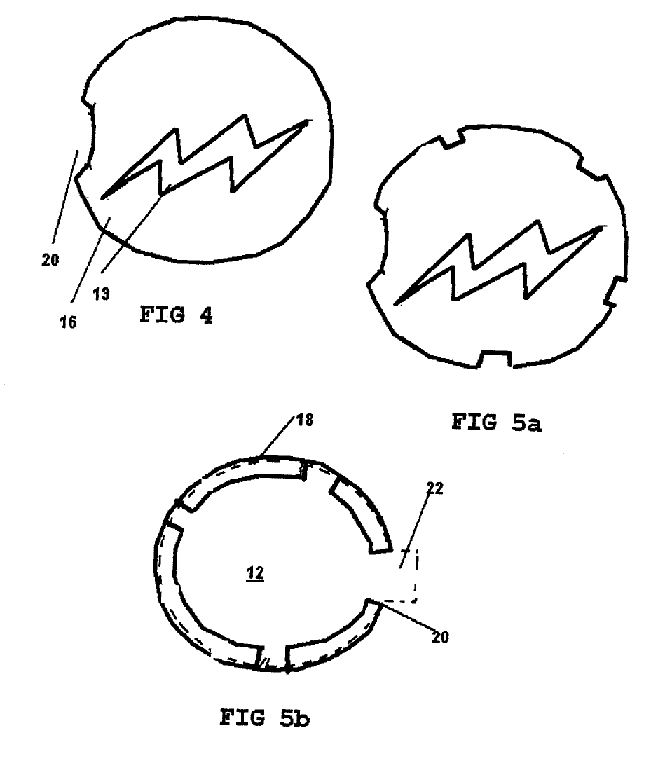

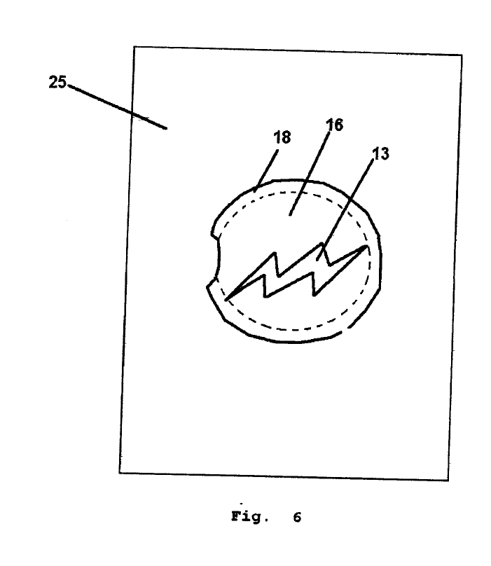

Referring now to FIGS. 1-6, where similar components are depicted with the same numerals, the device 10 as shown in FIG. 1, is depicted in an as-used position mounted to the fuel door 12 of a vehicle 14. Such an engagement is provided by the employment of a UV resistant flexible material forming the body 16 of the device 10 which is also adapted to shrink when heated to a defined temperature, such as by a blow dryer or other conventional device used to heat a surface.

A mounting of the device 10 is provided by a lip portion 18 which wraps around the circumferential edge of the fuel door 12 and maintains that position when the device 10 is shrunk by heat imparted to the device 10 by for instance a blow dryer. A rib or stabilizer may be inserted into or engaged with the lip portion 18 to help maintain its shape and grip upon the fuel door 12.

Also provided as shown in FIGS. 2-5, are one or a plurality of cut-outs 20 positioned for a registered engagement with the hinge 22 on such fuel doors 12.

The device 10 may also be provided as a kit adapted for user-printing of the indicia 13 using an inkjet or similar printer. In this mode, the body 16 would be engaged to a scrim 25, which will hold the body 16 flat and in position for indicia 13 to be imparted thereon. The user can thus put their own indicia on the device 10 or purchase the logos or indicia of their favorite sports team or other favorite indicia or logo or the like and using a digitized version thereof, and the device 10 fixed upon the scrim 25, they may print their own. Thereafter the device 10 would be mounted to the fuel door 12 in the same fashion using heat to shrink it.

Typically, the fuel door cover is made of a shrinkable polymer material. Typically, the shrinkable polymer material is heat-shrinkable. Typically, the heat-shrinkable polymer material is a polyolefin, such as a polyethylene including fractional melt virgin plastic resins and other additives. The thickness of the material is typically about 12 mil, but can be thicker or thinner if desired.

In one alternative, the fuel door cover is circular; if circular, the fuel door cover typically has a diameter of from about 1.5 inches to about 4.5 inches. In another alternative, the fuel door cover is ovoid in shape. In still another alternative, the fuel door cover is rectangular or square. The shape and dimensions of the fuel door cover are chosen to fit the shape and dimensions of the fuel door of a particular vehicle.

While all of the fundamental characteristics and features of the fuel door indicia device and method of configuring such, and employment thereof, have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the disclosed system and apparatus as defined by the following claims.

### ADVANTAGES OF THE INVENTION

The present invention provides a simple and effective way for a driver to display indicia on the fuel door of the vehicle, such as logos of his or her preferred sports team or other affiliation. The present invention allows such indicia to be removed or changed when desired without leaving an unsightly residue or damaging the paint or finish of the vehicle.

The present invention possesses industrial applicability as an article of manufacture capable of application to vehicle fuel doors for purposes of display and ornamentation.

With respect to ranges of values, the invention encompasses each intervening value between the upper and lower limits of the range to at least a tenth of the lower limit's unit, unless the context clearly indicates otherwise. Moreover, the invention encompasses any other stated intervening values and ranges including either or both of the upper and lower limits of the range, unless specifically excluded from the stated range.

Unless defined otherwise, the meanings of all technical and scientific terms used herein are those commonly understood by one of ordinary skill in the art to which this invention belongs. One of ordinary skill in the art will also appreciate that any methods and materials similar or equivalent to those described herein can also be used to practice or test this invention.

The publications and patents discussed herein are provided solely for their disclosure prior to the filing date of the present application. Nothing herein is to be construed as an admission that the present invention is not entitled to antedate such publication by virtue of prior invention. Further the dates of publication provided may be different from the actual publication dates which may need to be independently confirmed.

All the publications cited are incorporated herein by reference in their entireties, including all published patents, patent applications, and literature references, as well as those publications that have been incorporated in those published documents. However, to the extent that any publication incorporated herein by reference refers to information to be published, applicants do not admit that any such information published after the filing date of this application to be prior art.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A fuel door cover adapted for a shrink fit engagement upon a fuel door of a vehicle.

2. The fuel door cover of claim 1 wherein the fuel door cover is made of a shrinkable polymer material.

3. The fuel door cover of claim 2 wherein the shrinkable polymer material is heat-shrinkable.

4. The fuel door cover of claim 3 wherein the heat-shrinkable polymer material is a polyolefin.

5. The fuel door cover of claim 3 wherein the heat-shrinkable polymer material is a polyethylene including fractional melt virgin plastic resins and other additives.

6. The fuel door cover of claim 1 wherein the fuel door cover is circular.

7. The fuel door cover of claim 6 wherein the fuel door cover has a diameter of from about 1.5 inches to about 4.5 inches.

8. The fuel door cover of claim 1 wherein the fuel door cover is ovoid in shape.

9. The fuel door cover of claim 1 wherein the fuel door cover is square or rectangular.

10. The fuel door cover of claim 1 wherein the fuel door cover further comprises a lip portion adapted for wrapping around a circumferential edge of the fuel door.

11. The fuel door cover of claim 10 wherein the fuel door cover further comprises a rib or stabilizer inserted into or engaged with the lip portion.

12. The fuel door cover of claim 1 wherein the fuel door cover further comprises at least one cut-out positioned to engage registrably with a hinge of a fuel door.

13. A method for making a fuel door cover by positioning a planar portion of a fuel door cover upon a scrim adapted to hold the planar portion in a registered engagement with a printer; printing indicia thereon; and mounting said cover on a fuel door.
